(19) United States
(12) Patent Application Publication
(10) Pub. No.: US 2026/0152155 A1
(43) Pub. Date: Jun. 4, 2026

(54) WORK MACHINE AND METHOD FOR CONTROLLING WORK MACHINE

(71) Applicant: KOMATSU LTD., Tokyo (JP)

(72) Inventor: Akira TAKENO, Tokyo (JP)

(21) Appl. No.: 19/123,594

(22) PCT Filed: Sep. 12, 2023
(86) PCT No.: PCT/JP2023/033262

§ 371 Date: Apr. 23, 2025

(30) Foreign Application Priority Data
Nov. 30, 2022 (JP) 2022-191549

(51) Int. Cl. B60T 7/04; B60T 8/17; B60T 8/40; B60T 13/14; B60T 13/66; B60T 13/68; B60T 13/74

(52) U.S. Cl. CPC E02F 9/2083; B60T 7/12; B60T 8/171; B60T 8/172; B60T 13/662; B60T 13/686; E02F 9/2004; E02F 9/2253; F16H 61/4157; B60T 7/02; B60T 2220/04; E02F 9/2203; E02F 9/2285; E02F 9/2292

(57) ABSTRACT

A work machine includes a drive source, a transmission, a travel device, a brake device, and a controller. The transmission is connected to the drive source. The travel device is connected to the transmission and causes the work machine to travel. The brake device brakes the travel device. The controller acquires a brake command in order to brake the work machine. The controller determines a target braking force in response to the brake command. The controller acquires transmission information indicating a state of the transmission. The controller calculates an inertial braking force from the transmission based on the transmission information. The controller controls a braking force of the brake device based on a difference between the target braking force and the inertial braking force.

### CROSS-REFERENCE TO RELATED APPLICATIONS

This application is a U.S. National stage application of International Application No. PCT/JP2023/033262, filed on Sep. 12, 2023. This U.S. National stage application claims priority under 35 U.S.C. § 119(a) to Japanese Patent Application No. 2022-191549, filed in Japan on Nov. 30, 2022, the entire contents of which are hereby incorporated herein by reference.

### BACKGROUND

### Technical Field

The present invention relates to a work machine and a method for controlling a work machine.

### Background Art

Some work machines include a transmission. When an operator is not operating an accelerator pedal, a braking force is applied to the work machine by an inertial braking force from the transmission. For example, a work machine of WO 2021/066019 includes a hydrostatic transmission (HST). The HST includes a hydraulic pump and a hydraulic motor. In the HST, the inertial braking force is generated by an internal load of the hydraulic pump, the hydraulic motor, and an engine. The operator adjusts a vehicle speed of the work machine by utilizing such an inertial braking force.

### SUMMARY

Unfortunately, the inertial braking force from the transmission has limitations. Such limitations may cause the inertial braking force from the transmission to be insufficient for the required braking force in going down a slope, for example. The inertial braking force may also change depending on a state of the transmission. This makes it difficult to stably adjust the vehicle speed of the work machine by the inertial braking force. An object of the disclosure is to obtain a stable braking force in a work machine regardless of an insufficiency or a fluctuation in an inertial braking force.

A work machine according to an aspect of the disclosure includes a drive source, a transmission, a travel device, a brake device, and a controller. The transmission is connected to the drive source. The travel device is connected to the transmission and causes the work machine to travel. The brake device brakes the travel device. The controller acquires a brake command for braking the work machine. The controller determines a target braking force in response to the brake command. The controller acquires transmission information indicating a state of the transmission. The controller calculates an inertial braking force from the transmission based on the transmission information. The controller controls a braking force of the brake device based on a difference between the target braking force and the inertial braking force.

A method according to another aspect of the disclosure is a method for controlling a work machine. The work machine includes a drive source, a transmission, a travel device, and a brake device. The transmission is connected to the drive source. The travel device is connected to the transmission and causes the work machine to travel. The brake device brakes the travel device. The method includes acquiring a brake command for braking the work machine, determining a target braking force in response to the brake command, acquiring transmission information indicating a state of the transmission, calculating an inertial braking force from the transmission based on the transmission information, and controlling a braking force of the brake device based on a difference between the target braking force and the inertial braking force.

According to the disclosure, a braking force of a brake device is controlled based on a difference between a target braking force and an inertial braking force. Thus, when the inertial braking force is insufficient relative to the target braking force, the insufficiency is compensated by the braking force of the brake device. The target braking force is determined even if the inertial braking force fluctuates, making it possible to obtain a stable braking force. This can obtain a stable braking force in the work machine regardless of an insufficiency or a fluctuation in the inertial braking force.

### BRIEF DESCRIPTION OF DRAWINGS

FIG. 1 is a side view of a work machine according to an embodiment.

FIG. 2 is a block diagram illustrating a configuration of the work machine.

FIG. 3 is a diagram illustrating an example of driving force characteristics of the work machine.

FIG. 4 is a diagram illustrating a configuration of a hydraulic circuit for driving brake devices.

FIG. 5 is a flowchart illustrating processing of automatic brake control.

FIG. 6 is a diagram illustrating an example of a target braking force of a first level.

FIG. 7 is a view illustrating an example of a target braking force of a second level.

FIG. 8 is a diagram illustrating an example of a target braking force of a third level.

### DETAILED DESCRIPTION OF EMBODIMENT(S)

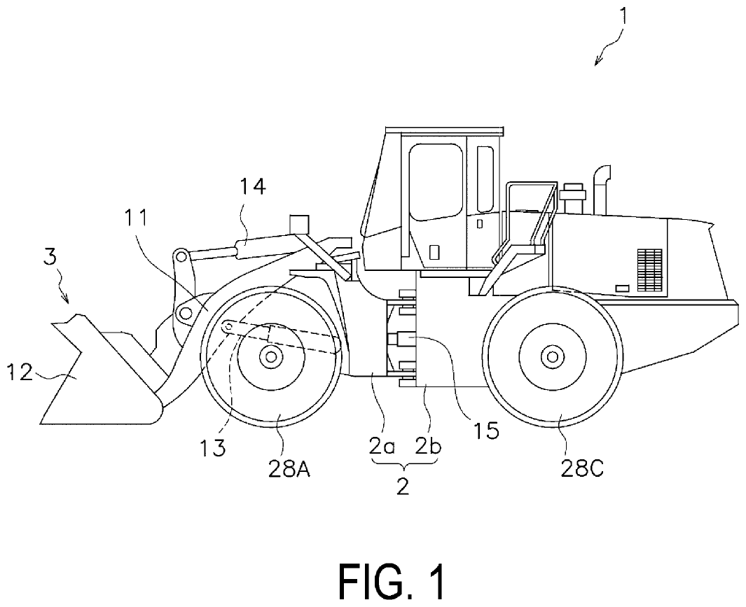

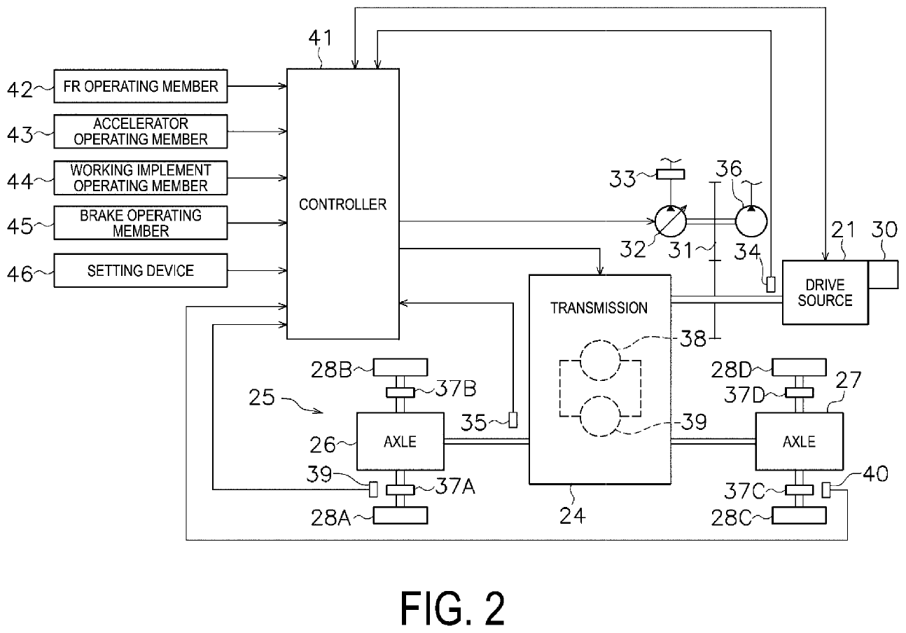

Hereinafter, an embodiment of the disclosure will be described in detail with reference to the drawings. FIG. 1 is a side view of a work machine 1 according to the embodiment. FIG. 2 is a block diagram illustrating a configuration of the work machine 1. In the present embodiment, the work machine 1 is a wheel loader. As illustrated in FIG. 1, the work machine 1 includes a vehicle body 2 and a work implement 3.

The vehicle body 2 includes a front vehicle body 2a and a rear vehicle body 2b. The rear vehicle body 2b is connected rotatably leftward and rightward to the front vehicle body 2a. A hydraulic cylinder 15 is coupled to the front vehicle body 2a and the rear vehicle body 2b. The hydraulic cylinder 15 extends and contracts, rotating the front vehicle body 2a leftward and rightward relative to the rear vehicle body 2b.

The work implement 3 is used for work such as excavation. The work implement 3 is operably attached to the front vehicle body 2a. The work implement 3 includes a boom 11, a bucket 12, and hydraulic cylinders 13, 14. The boom 11 and the bucket 12 operate by extension and contraction of the hydraulic cylinders 13, 14.

As illustrated in FIG. 2, the work machine 1 includes a drive source 21, a transmission 24, and a travel device 25. The drive source 21 is, for example, a diesel engine. The drive source 21 is provided with a fuel injection device 30. The fuel injection device 30 controls output of the drive source 21 by adjusting a fuel amount injected into a cylinder of the drive source 21.

The transmission 24 is connected to the drive source 21. The transmission 24 transmits a driving force from the drive source 21 to the travel device 25. For example, the transmission 24 is a hydrostatic transmission (HST) and includes a hydraulic pump 38 and a hydraulic motor 39. The transmission 24 can steplessly change a gear ratio by controlling respective capacities of the hydraulic pump 38 and the hydraulic motor 39.

However, the transmission 24 may be another type of transmission such as an electric mechanical transmission (EMT) or a hydraulic mechanical transmission (HMT). Alternatively, the transmission 24 may be a transmission including a torque converter and a plurality of transmission gears.

The travel device 25 is mounted onto the vehicle body 2 and driven by the driving force from the drive source 21, causing the vehicle body 2 to travel. The travel device 25 includes axles 26, 27, front wheels 28A, 28B, and rear wheels 28C, 28D. The axles 26, 27 are connected to the transmission 24. The front wheels 28A, 28B are provided to the front vehicle body 2a. The rear wheels 28C, 28D are provided to the rear vehicle body 2b. The axle 26 transmits the driving force from the transmission 24 to the front wheels 28A, 28B. The axle 27 transmits the driving force from the transmission 24 to the rear wheels 28C, 28D.

The work machine 1 includes a power take off (PTO) 31, a work implement pump 32, and a control valve 33. The PTO 31 distributes the driving force of the drive source 21 to the transmission 24 and the work implement pump 32. FIG. 2 only illustrates one work implement pump 32. However, two or more hydraulic pumps may be connected to the drive source 21 through the PTO 31.

The work implement pump 32 is connected to the drive source 21 through the PTO 31. The work implement pump 32 is a hydraulic pump. The work implement pump 32 is driven by the drive source 21 and discharges hydraulic oil. The hydraulic oil discharged from the work implement pump 32 is supplied to the hydraulic cylinders 13 to 15 described above. The control valve 33 controls a flow rate of the hydraulic oil supplied from the work implement pump 32 to the hydraulic cylinders 13 to 15. The control valve 33 is, for example, an electromagnetic proportional control valve and is controlled in accordance with an input electric signal. Alternatively, the control valve 33 may be a pressure proportional control valve and may be controlled in accordance with an input pilot pressure.

The work machine 1 includes a brake pump 36 and brake devices 37A to 37D. The brake devices 37A to 37D are hydraulic brakes. The brake pump 36 is driven by the drive source 21 and discharges hydraulic oil. The hydraulic oil discharged from the brake pump 36 is supplied to the brake devices 37A to 37D. The brake devices 37A to 37D are driven by the hydraulic oil, thereby braking the travel device 25. The brake devices 37A to 37D are, for example, wet-type multi-plate brakes. Specifically, the brake devices 37A to 37D include the front brakes 37A, 37B and the rear brakes 37C, 37D. The front brakes 37A, 37B brake the front wheels 28A, 28B. The rear brakes 37C, 37D brake the rear wheels 28C, 28D.

The work machine 1 includes an engine sensor 34 and a vehicle speed sensor 35. The engine sensor 34 detects an engine rotation speed. The vehicle speed sensor 35 detects a vehicle speed. The vehicle speed sensor 35 detects, for example, an output rotation speed of the travel device 25 as the vehicle speed. The output rotation speed of the travel device 25 corresponds to the vehicle speed of the work machine 1. The output rotation speed of the travel device 25 is, for example, a rotation speed of an output shaft of the transmission 24. However, the output rotation speed may be the rotation speed of another rotating element located in the transmission 24 or downstream of the transmission 24.

The work machine 1 includes a controller 41. The controller 41 includes a processor such as a central processing unit (CPU) and a storage device such as a RAM and a ROM. The controller 41 may include an auxiliary storage device such as a hard disk or a solid state drive (SSD). The controller 41 stores a program and data for controlling the work machine 1. The controller 41 executes processing for controlling the work machine 1 in accordance with the stored program and data.

The controller 41 receives a signal indicating the engine rotation speed from the engine sensor 34. The controller 41 receives a signal indicating the output rotation speed from the vehicle speed sensor 35.

The controller 41 controls the output of the drive source 21 by transmitting a command signal to the drive source 21. The controller 41 switches between a forward gear and a reverse gear of the transmission 24 by transmitting a command signal to the transmission 24. The controller 41 controls the gear ratio of the transmission 24 by transmitting a command signal to the transmission 24. The controller 41 controls the work implement 3 by transmitting command signals to the work implement pump 32 and the control valve 33.

The work machine 1 includes a forward-reverse (FR) operating member 42, an accelerator operating member 43, a work implement operating member 44, a brake operating member 45, and a setting device 46. The FR operating member 42 is operable by an operator to switch between forward movement and reverse movement of the work machine 1. The FR operating member 42 is operable from a neutral position to a forward position and a reverse position. The FR operating member 42 is, for example, a lever. However, the FR operating member 42 may be another member such as a switch or a pedal.

The accelerator operating member 43 is operable by the operator to control the vehicle speed of the work machine 1. The accelerator operating member 43 is, for example, a pedal. However, the accelerator operating member 43 may be another member such as a lever or a switch. The work implement operating member 44 is operable by the operator to control the work implement 3. The work implement operating member 44 is, for example, a lever. However, the work implement operating member 44 may be another member such as a switch or a pedal.

The controller 41 receives a signal indicating an operation position of the FR operating member 42 from the FR operating member 42. The controller 41 switches between the forward gear and the reverse gear of the transmission 24 in accordance with a signal from the FR operating member 42. The controller 41 receives a signal indicating an accelerator operation amount from the accelerator operating member 43. The accelerator operation amount is an operation amount of the accelerator operating member 43.

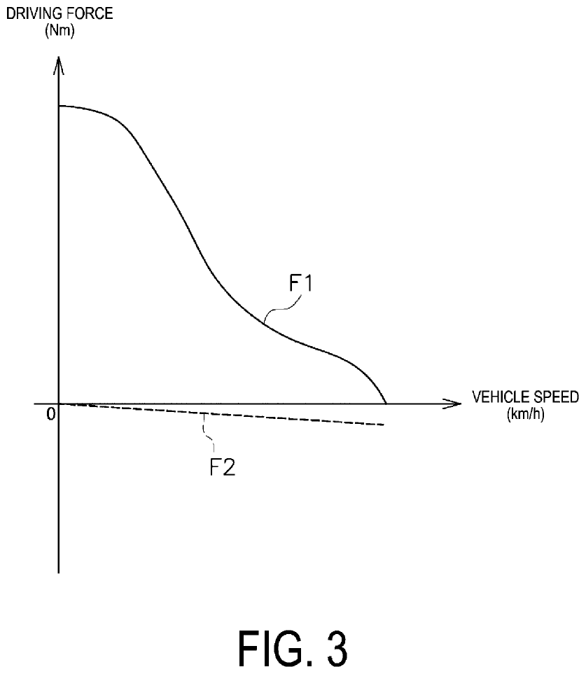

FIG. 3 is a diagram illustrating driving force characteristics of the work machine 1. In FIG. 3, a solid line F1 indicates the driving force characteristics when the accelerator operation amount is 100%. In FIG. 3, a dashed line F2 indicates the driving force characteristics when the accelerator operation amount is 0%. The controller 41 controls the drive source 21 and the transmission 24 so as to obtain the driving force characteristics illustrated in FIG. 3 in accordance with the accelerator operation amount and the vehicle speed.

As illustrated in FIG. 3, the driving force includes a positive value and a negative value. A driving force having a positive value indicates a positive driving force for causing the work machine 1 to travel. A driving force having a negative value indicates a negative driving force for braking the work machine 1, that is, an inertial braking force from the transmission 24. The inertial braking force is a so-called engine brake and is a braking force due to an internal load of the transmission 24 and the drive source 21.

The brake operating member 45 is operable by the operator to drive the brake devices 37A to 37D. The brake operating member 45 is, for example, a pedal. However, the brake operating member 45 may be another member such as a lever or a switch. The hydraulic pressure of the hydraulic oil supplied to the brake devices 37A to 37D is controlled in accordance with operation of the brake operating member 45. This causes the brake devices 37A to 37D to generate a braking force in accordance with an operation amount of the brake operating member 45.

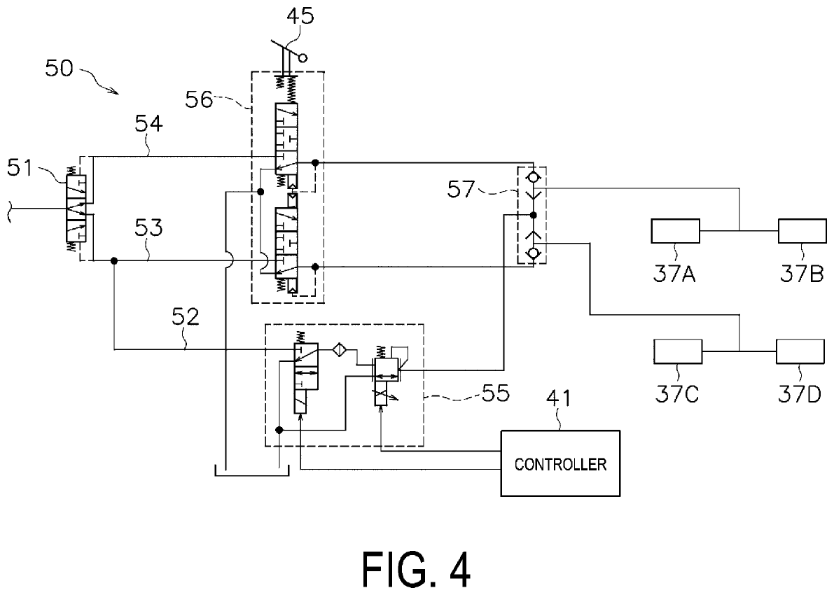

FIG. 4 is a diagram illustrating a hydraulic circuit 50 for driving the brake devices 37A to 37D. As illustrated in FIG. 4, the hydraulic circuit 50 includes a flow-dividing valve 51, a first flow path 52, a second flow path 53, a third flow path 54, an automatic brake valve 55, a manual brake valve 56, and a shuttle valve 57. The flow-dividing valve 51 divides the hydraulic oil from the brake pump 36 described above into the second flow path 53 and the third flow path 54. The first flow path 52 is connected to the second flow path 53.

The automatic brake valve 55 is electrically connected to the controller 41. The automatic brake valve 55 is, for example, an electromagnetic valve and is electrically controlled in accordance with a command signal from the controller 41. The automatic brake valve 55 changes a hydraulic pressure (hereinafter referred to as first hydraulic pressure) supplied from the automatic brake valve 55 to the brake devices 37A to 37D through the first flow path 52 in accordance with the command signal from the controller 41.

The manual brake valve 56 is connected to the brake operating member 45. The manual brake valve 56 is mechanically connected to the brake operating member 45 through a link member such as a spring. The manual brake valve 56 is connected to the second flow path 53 and the third flow path 54. The manual brake valve 56 changes a hydraulic pressure (hereinafter referred to as second hydraulic pressure) supplied from the manual brake valve 56 to the brake devices 37A to 37D through the second flow path 53 and the third flow path 54 in accordance with the operation amount of the brake operating member 45.

The shuttle valve 57 is connected to the first flow path 52, the second flow path 53, and the third flow path 54. The shuttle valve 57 selectively supplies the first hydraulic pressure from the automatic brake valve 55 and the second hydraulic pressure from the manual brake valve 56 to the brake devices 37A to 37D. In detail, the shuttle valve 57 supplies a larger one of the first hydraulic pressure and the second hydraulic pressure to the brake devices 37A to 37D. Accordingly, when the first hydraulic pressure by operation of the brake operating member 45 by the operator is greater than the second hydraulic pressure based on the command signal from the controller 41, for example, the first hydraulic pressure is supplied to the brake devices 37A to 37D. This controls the braking force of the brake devices 37A to 37D in accordance with the operation amount of the brake operating member 45 by the operator.

Conversely, when the second hydraulic pressure based on the command signal from the controller 41 is greater than the first hydraulic pressure based on operation of the brake operating member 45 by the operator, the second hydraulic pressure is supplied to the brake devices 37A to 37D. This controls the braking force of the brake devices 37A to 37D in accordance with the command signal from the controller 41.

In the work machine 1 according to the present embodiment, the controller 41 executes automatic brake control for automatically controlling the braking force during inertial travel of the work machine 1. The inertial travel of the work machine 1 refers to a state in which the work machine 1 travels by inertia in a state of the accelerator operating member 43 and the brake operating member 45 not being operated. The setting device 46 is operable by the operator to set a target braking force during inertial travel of the automatic brake control. The setting device 46 is, for example, a dial-type switch. However, the setting device may be another device such as a slide-type switch, a push-button-type switch, or a touch panel. The setting device 46 outputs a brake command indicating the target braking force in accordance with an operation by the operator.

The target braking force is represented by a plurality of levels. The plurality of levels include, for example, a first level, a second level, and a third level. The target braking force of the first level is the largest. The target braking force of the third level is the smallest. The target braking force of the second level has a magnitude between the first level and the second level.

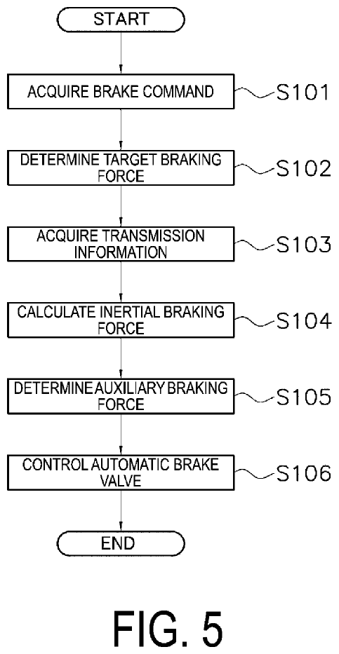

FIG. 5 is a flowchart illustrating processing of the automatic brake control. As illustrated in FIG. 5, in step S101, the controller 41 acquires a brake command. The controller 41 acquires the brake command indicating the target braking force set by the operator by using the setting device 46.

In step S102, the controller 41 determines the target braking force. The controller 41 determines the target braking force in response to the brake command from the setting device 46. In step S103, the controller 41 acquires transmission information. The transmission information indicates a state of the transmission 24. The transmission information includes, for example, the gear ratio of the transmission 24. When the transmission 24 is an HST, the transmission information may include the capacity of the hydraulic pump and the capacity of the hydraulic motor. When the transmission 24 includes a plurality of transmission gears, the transmission information may include the gear ratios of the transmission gears. The transmission information may include the vehicle speed.

In step S104, the controller 41 calculates the inertial braking force from the transmission 24. The controller 41 calculates the inertial braking force from the transmission 24 based on the transmission information described above.

In step S105, the controller 41 determines the auxiliary braking force. The controller 41 determines the auxiliary braking force such that the target braking force is obtained by the inertial braking force from the transmission 24 and the auxiliary braking force of the brake devices 37A to 37D. The controller 41 determines the braking force corresponding to a difference between the target braking force and the inertial braking force as the auxiliary braking force.

In step S106, the controller 41 controls the automatic brake valve 55. The controller 41 calculates a target brake hydraulic pressure of the brake devices 37A to 37D corresponding to the auxiliary braking force. The controller 41 controls an opening degree of the automatic brake valve 55 such that the target brake hydraulic pressure is supplied to the brake devices 37A to 37D.

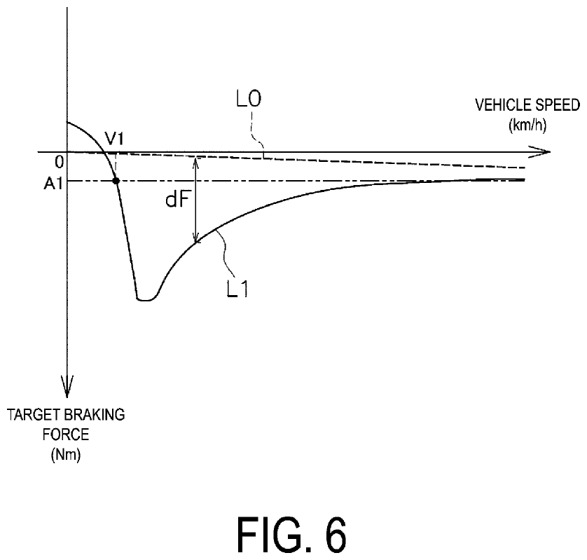

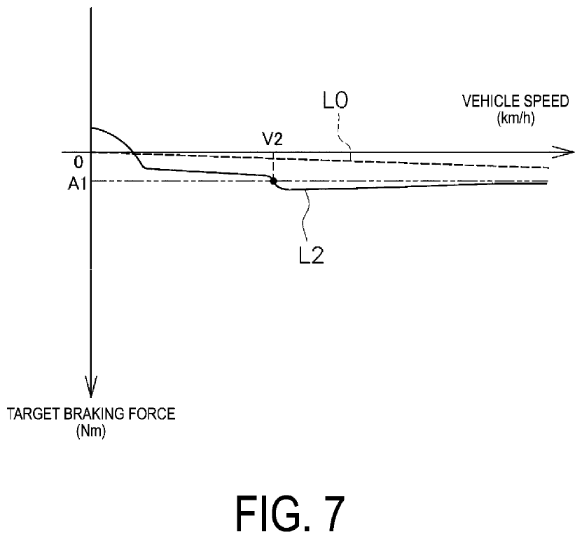

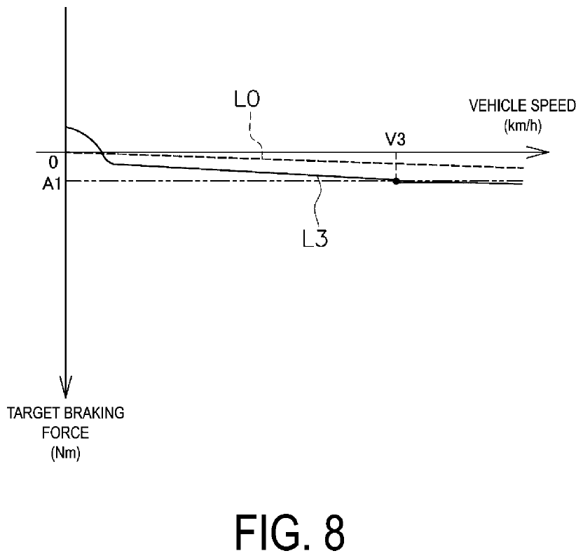

For example, in FIG. 6, L1 represents an example of the target braking force of the first level. In FIG. 7, L2 represents an example of the target braking force of the second level. In FIG. 8, L3 represents an example of the target braking force of the third level. The relationship between the target braking forces L1 to L3 of the first to third levels and the vehicle speed is stored in the controller 41.

As illustrated in FIG. 6, when the first level is set as the target braking force by the setting device 46, the controller 41 determines the target braking force L1 corresponding to the vehicle speed. In FIG. 6, L0 represents an inertial braking force from the transmission 24 during inertial travel. The controller 41 calculates the inertial braking force L0 from the transmission information. The controller 41 calculates the target brake hydraulic pressure of the brake devices 37A to 37D so as to generate the auxiliary braking force corresponding to a difference dF between the target braking force L1 and the inertial braking force L0. The controller 41 controls the opening degree of the automatic brake valve 55 such that the target brake hydraulic pressure is supplied to the brake devices 37A to 37D. As a result, even if the inertial braking force L0 is insufficient relative to the target braking force L1 of the first level, the braking force according to the target braking force L1 of the first level is obtained by compensation by the auxiliary braking force of the brake devices 37A to 37D.

As illustrated in FIG. 7, the target braking force L2 of the second level is less than the target braking force L1 of the first level. When the second level is set as the target braking force by the setting device 46, the controller 41 determines the target braking force L2 corresponding to the vehicle speed. Hereafter, as in the case in which the first level is set, the controller 41 calculates the target brake hydraulic pressure of the brake devices 37A to 37D so as to generate the auxiliary braking force corresponding to a difference between the target braking force L2 and the inertial braking force L0 and controls the opening degree of the automatic brake valve 55 according to the target brake hydraulic pressure.

As illustrated in FIG. 8, the target braking force L3 of the third level is less than the target braking force L2 of the second level. When the third level is set as the target braking force by the setting device 46, the controller 41 determines the target braking force L3 corresponding to the vehicle speed. Hereafter, as in the case in which the first level is set, the controller 41 calculates the target brake hydraulic pressure of the brake devices 37A to 37D so as to generate the auxiliary braking force corresponding to a difference between the target braking force L3 and the inertial braking force L0 and controls the opening degree of the automatic brake valve 55 according to the target brake hydraulic pressure.

As described above, the target braking force is changed by the setting device 46, making it possible to change the braking force during inertial travel. Therefore, when traveling on the same downhill slope, the work machine 1 can change the vehicle speed at which the work machine 1 stabilizes during inertial travel. Further, the work machine 1 can travel at a constant vehicle speed even on a downhill slope on which stabilization cannot be achieved by the inertial braking force from the transmission 24 alone. Note that stabilization here refers to a state in which the work machine 1 travels at a constant speed during inertial travel.

For example, as illustrated in FIG. 6 to FIG. 8, when the work machine 1 travels on a certain downhill slope, a braking force (hereinafter called stabilizing braking force) that balances with the force for accelerating the work machine 1 is defined as A1. When the inertial braking force L0 from the transmission 24 is less than the stabilizing braking force A1, the work machine 1 cannot be stabilized by the inertial braking force from the transmission 24 alone.

Therefore, as illustrated in FIG. 6, the target braking force is set to the level 1 by the setting device 46, making it possible to obtain a braking force corresponding to the target braking force L1 of the level 1. This allows, at a vehicle speed V1 at which the target braking force L1 is balanced with the stabilizing braking force A1, the work machine 1 to travel at a constant speed.

As illustrated in FIG. 7, the target braking force is set to the level 2 by the setting device 46, making it possible to obtain a braking force corresponding to the target braking force L2 of the level 2. This allows, at a vehicle speed V2 at which the target braking force L2 is balanced with the stabilizing braking force A1, the work machine 1 to travel at a constant speed.

As illustrated in FIG. 8, the target braking force is set to the level 3 by the setting device 46, making it possible to obtain a braking force corresponding to the target braking force L3 of the level 3. This allows, at a vehicle speed V3 at which the target braking force L3 is balanced with the stabilizing braking force A1, the work machine 1 to travel at a constant speed. As described above, when the work machine 1 travels on the same downhill slope, the operator can change the vehicle speed at which the work machine 1 is stabilized during inertial travel by changing the target braking force by the setting device 46.

In the work machine 1 according to the present embodiment described above, the braking force of the brake devices 37A to 37D is controlled based on the difference between the target braking force and the inertial braking force. Therefore, when the inertial braking force is insufficient relative to the target braking force, the insufficiency can be compensated by the braking force of the brake devices 37A to 37D. The target braking force is determined even if the inertial braking force fluctuates, making it possible to obtain a stable braking force. This can obtain a stable braking force in the work machine 1 regardless of an insufficiency or a fluctuation in the inertial braking force.

Although one embodiment of the present invention has been described above, the present invention is not limited to the embodiment described above, and various modifications can be made without departing from the gist of the invention.

The work machine 1 is not limited to a wheel loader and may be another machine such as a bulldozer or a motor grader. The work machine 1 may be remotely operable. In this case, the FR operating member 42, the accelerator operating member 43, the work implement operating member 44, the brake operating member 45, and the setting device 46 may be disposed outside the work machine 1.

The drive source 21 is not limited to an engine and may include an electric motor. The controller 41 may be composed of a plurality of controllers. The processing for controlling the work machine 1 described above may be distributed to and executed by the plurality of controllers.

The processing of the automatic brake control is not limited to that of the embodiment described above and may be changed. For example, the number of levels of the target braking force is not limited to three. The number of levels of the target braking force may be more than three or may be less than three. The target braking force may be represented by a numerical value of the braking force.

The present disclosure allows the work machine to obtain a stable braking force regardless of an insufficiency or a fluctuation in an inertial braking force.

1. A work machine, comprising:
a drive source;
a transmission connected to the drive source;
a travel device connected to the transmission and configured to cause the work machine to travel;
a brake device configured to brake the travel device; and
a controller configured to
acquire a brake command in order to brake the work machine,
determine a target braking force in response to the brake command,
acquire transmission information indicating a state of the transmission,
calculate an inertial braking force from the transmission based on the transmission information, and
control a braking force of the brake device based on a difference between the target braking force and the inertial braking force.

2. The work machine according to claim 1, further comprising:
a setting device operable by an operator to set the target braking force,
the controller being configured to acquire the brake command corresponding to an operation of the setting device.

3. The work machine according to claim 1, wherein
the brake device is a hydraulic brake,
the work machine further comprises an automatic brake valve configured to change a first hydraulic pressure to the brake device by being controlled by the controller, and
the controller is configured to control the automatic brake valve to change the first hydraulic pressure to the brake device in accordance with the difference between the target braking force and the inertial braking force.

4. The work machine according to claim 3, further comprising:
a brake operating member operable by an operator to adjust a braking force of the brake device;
a manual brake valve configured to change a second hydraulic pressure to the brake device in accordance with an operation of the brake operating member; and
a shuttle valve configured to selectively supply, to the brake device, the first hydraulic pressure from the automatic brake valve and the second hydraulic pressure from the manual brake valve.

5. The work machine according to claim 4, wherein
the shuttle valve is configured to supply a larger one of the first hydraulic pressure and the second hydraulic pressure to the brake device.

6. A method for controlling a work machine including a drive source, a transmission connected to the drive source, a travel device connected to the transmission and configured to cause the work machine to travel, and a brake device configured to brake the travel device, the method comprising:
acquiring a brake command in order to brake the work machine;
determining a target braking force in response to the brake command;
acquiring transmission information indicating a state of the transmission;
calculating an inertial braking force from the transmission based on the transmission information; and
controlling a braking force of the brake device based on a difference between the target braking force and the inertial braking force.

7. The method according to claim 6, wherein
the brake command corresponds to an operation of a setting device operable by an operator to set the target braking force.

8. The method according to claim 6, wherein
the brake device is a hydraulic brake,
the work machine includes an automatic brake valve configured to change the first hydraulic pressure to the brake device, and
the method comprises controlling the automatic brake valve to change a first hydraulic pressure to the brake device in accordance with the difference between the target braking force and the inertial braking force.
